(19) United States
(12) Patent Application Publication
(10) Pub. No.: US 2012/0155501 A1
(43) Pub. Date: Jun. 21, 2012

(54) ANGULAR EXTRUSION OF COPPER ALLOY ANODES

(75) Inventors: Stephane Ferrasse, Spokane, WA (US); Frank Alford, Spokane Valley, WA (US); Kay Dean Bowles, Greenacres, WA (US)

(73) Assignee: Honeywell International Inc., Morristown, NJ (US)

(21) Appl. No.: 12/970,556

(22) Filed: Dec. 16, 2010

(51) Int. Cl. H01S 3/00; B21C 23/01; B21C 23/08; C22F 1/08; B32B 5/18

(52) U.S. Cl. 372/38.05; 148/564; 428/613; 72/253.1; 72/256; 72/255

(57) ABSTRACT

A method of manufacturing an electrode, in which a solid metal material is extruded through a channel angular extrusion die to form the electrode. The solid metal material comprises copper and at least about 10 wt % zinc, and more particularly, between about 20 and about 40 wt % zinc. Prior to extrusion, the solid metal material may be formed by casting, hot forging, machining and/or hot isostatic pressure such that the solid metal material has dimensions corresponding to the CAE die. After extrusion, the solid metal material can be rolled and/or cut to a desired electrode shape.

### FIELD OF THE INVENTION

The invention relates generally to methods of manufacturing electrodes to reduce void size and/or count and to electrodes for lasers and other systems.

### BACKGROUND

Light sources such as lasers are utilized extensively for photolithography applications in semiconductor manufacturing. These light sources include electrodes (i.e., anodes and cathodes) often formed from copper and copper alloys that are expended over the life of the laser.

Increasing requirements for laser power have resulted in higher voltage across electrodes and higher total power dissipated in the discharges over the life of the electrode. As such, there is an ongoing challenge to manufactures electrodes from materials with reduced impurities, voids and grain size so that the electrode can function for an extended period under such conditions.

### SUMMARY OF THE INVENTION

One embodiment is a method of manufacturing an electrode, in which a solid metal material is extruded through a channel angular extrusion (CAE) die, and an electrode is then formed from the extruded solid metal material. The solid metal material comprises copper and at least about 10 wt % zinc, and more particularly, between about 20 and about 40 wt % zinc. Prior to extrusion, the solid metal material may be formed by casting, hot forging, cutting, machining and/or hot isostatic pressure such that the solid metal material has dimensions corresponding to the inlet channel of the CAE die. After extrusion, the solid metal material can be rolled, cut and/or machined to form an electrode.

Another embodiment is an electrode comprising copper and between about 20 wt % and 40 wt % zinc. The electrode has an average grain size of less than 2 microns and a maximum void size of less than 5 microns. A further embodiment is a laser comprising such an electrode.

### BRIEF DESCRIPTION OF THE DRAWINGS

FIG. 1 is a schematic of an equal channel angular extrusion (ECAE) process showing a partially extruded billet in accordance with an embodiment of the present invention.

FIGS. 2A through 2E illustrate billet orientations during multiple pass ECAE processing.

FIG. 3 is a flow chart illustrating a method of manufacturing an electrode according to an embodiment of the present invention.

FIG. 4 is a flow chart illustrating another method of manufacturing an electrode according to an embodiment of the present invention.

### DETAILED DESCRIPTION

Embodiments of the present invention are directed to methods of manufacturing electrodes, and more particularly, cathodes and anodes for use in laser systems. Embodiments of the present invention are also directed to electrodes, formed from copper alloys such as brass, that have reduced void size, void count and/or grain size.

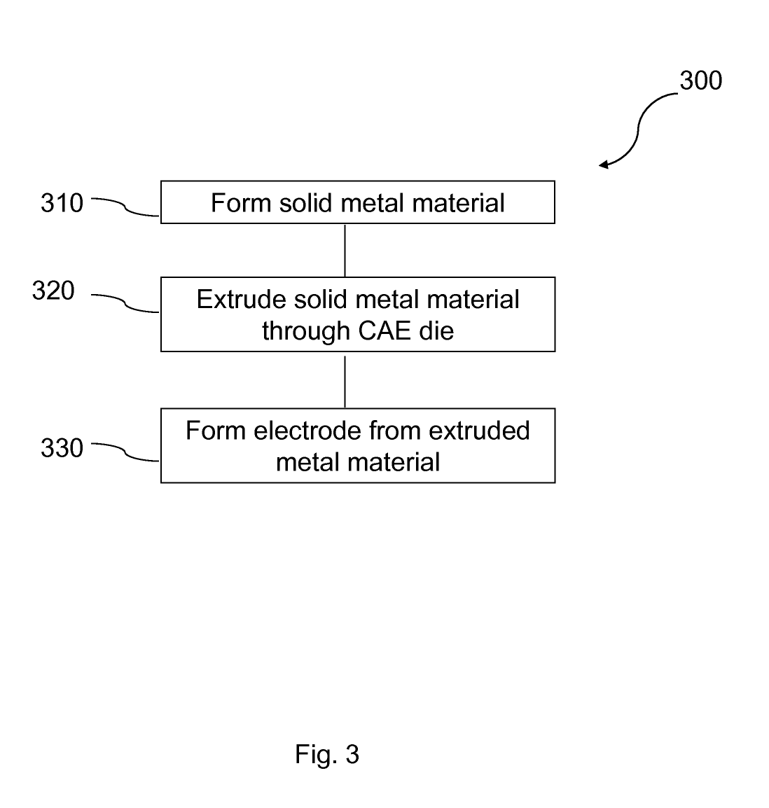

FIG. 3 is a flow-chart illustrating one method 300 of manufacturing an electrode. The method 10 generally involves the steps of forming a solid metal material such as a billet sized and shaped for extrusion through a channel angular extrusion (CAE) die (block 310), extruding the solid metal material one or more times through the CAE die (block 320) and then forming one or more electrodes from the extruded solid metal material (block 330).

### Forming a Solid Metal Material (Block 310)

The solid metal material may be formed and shaped from a variety of known techniques. In one embodiment, a liquid metal material is cast into desired dimensions (e.g., length, width, thickness, radius) that correspond generally to the cross-section and/or profile (e.g., square, rectangular or cylindrical shape) of the CAE die, and in particular, the inlet channel through which the solid metal material is to be extruded. Conventional casting techniques such as permanent mold casting may be utilized to form the solid metal material.

In some instances, the shape and/or dimensions of the cast metal material is then further formed by cutting, machining and/or rolling to a more precise dimension prior to extruding. Additionally or alternatively, the cast metal material may be subjected to a hot forge process to reduce the thickness of the metal. However, a hot forge process is not required and is eliminated according to certain embodiments.

A variety of metals and metal alloys may be used to form the solid metal material. In one embodiment, a copper alloy is used. For example, a copper alloy including at least 10 wt % of at least one additional metal such as zinc may be used. In a particular embodiment, the copper alloy is a brass alloy comprising at least about 10 wt % zinc, more particularly, from about 10 wt % to 40 wt % zinc, even more particularly, from about 20 wt % to 38 wt % zinc, and even more particularly, from about 25 wt % to about 35 wt % zinc. A specific example includes between about 29 wt % and 32 wt % zinc.

The solid metal material may also include one or more additional metals including, for example, Pb, Be, Mn, Te, Cr, P, Sn, As, Sb, Fe, Al, Ni, Si, Ag, Cd, Mg, Bi, Sb, In, Au, Ge, As, Co and TI. These metals may be present in amounts up to about 15 wt %. In particular, small quantities of Pb, Be, Mn, Te, Cr, P, Sn, As and Sb may be beneficial for corrosion prevention. In one embodiment, however, the solid metal material is free of additional metals other than copper, zinc and low concentrations of metal impurities (if any).

### Extruding the Solid Metal Material (Block 320)

After the solid metal material is formed, it is then extruded through a CAE die. CAE processes are designed to force a solid metal object through a die with a turn or intersection (e.g., 90°) between the inlet channel and outlet channel of the die. This turn results in plastic deformation particularly at the surface of the material, and is generally known to reduce the grain size and grain alignment of solid metal materials such as copper.

The most common ECA process is referred to as equal channel angular extrusion (ECAE), in which the inlet channel and the outlet channel of the die have equal dimensions. Additional information relating to ECAE of metal materials is disclosed in U.S. Pat. Nos. 5,590,389, 5,780,755, 7,767,043 and 6,723,187 each of which is hereby incorporated by reference in its entirety. Another type of ECA die is an unequal or changing channel angular extrusion die, in which the inlet and outlet channels have different dimensions.

FIG. 1 is a schematic of an equal channel angular extrusion (ECAE) process 100 showing a partially extruded solid metal material or billet of material 102 in accordance with one embodiment of the present invention. ECAE process 100, which is illustrative of a conventional ECAE process, may be utilized to carry out the present invention to effectively plastically deform all regions of the microstructure of billet 102.

ECAE process 100 includes an ECAE die 104 having an inlet channel 106 and an outlet channel 108, the axes of which create an ECAE die angle 110. ECAE die 104 may be any suitable size and shape and may be formed from any suitable material. Inlet channel 106 and outlet channel 108 have nominally the same dimensions and area, which is typical in the conventional ECAE process. ECAE die angle 110, in the illustrated embodiment, is approximately 90°; however, other suitable angles may be utilized.

Having inlet channel 106 and outlet channel 108 at ECAE die angle 110 creates a shear plane 112 at the transition from inlet channel 106 to outlet channel 108 that functions to plastically deform the material of billet 102 as it passes through shear plane 112. To briefly illustrate the simple shear that billet 102 is subjected to, one face of an original volumetric material element 114 of billet 102 is illustrated within inlet channel 106 to be generally square. Material element 114 represents one face of a volume element that passes through the billet to the opposite side of the billet. For clarity, material element 114 may be thought of as a single grain of billet 102. After passing through shear plane 112, material element 114 is sheared into a sheared material element 116. In essence, the grains of billet 102 elongate as a result of a single pass through shear plane 112.

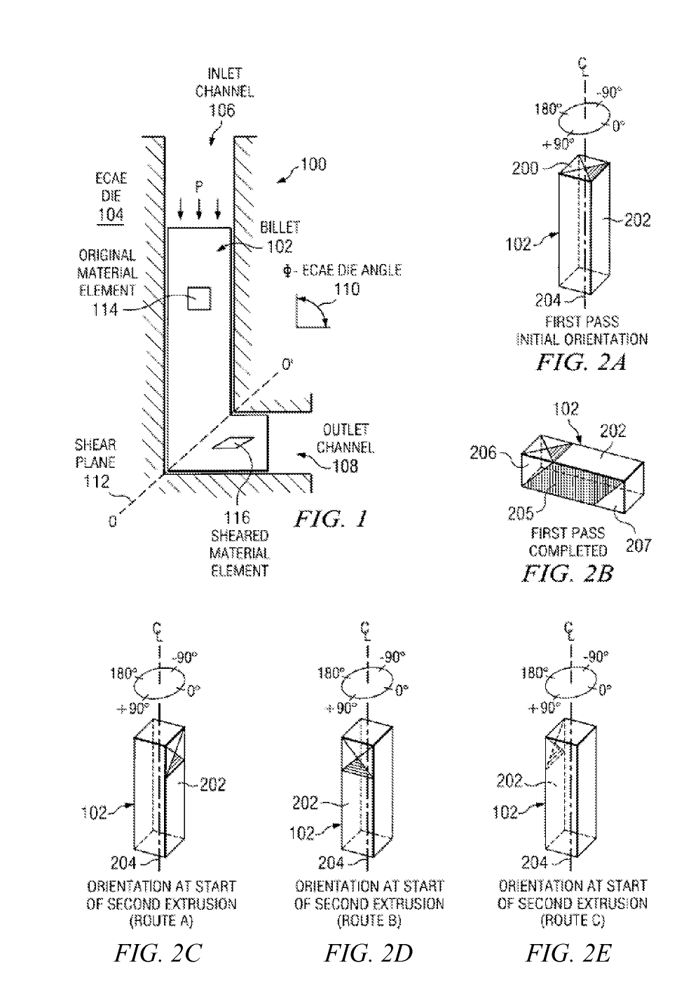

In order for billet 102 to be extruded through inlet channel 106 and outlet channel 108, a pressure 118 is applied to the top of billet 102. This pressure 118 may be applied by any suitable method, such as a punch, hydrostatic pressure, or other suitable method. The amount of pressure 118 applied is dependent upon billet material and processing parameters. Once billet 102 exits outlet channel 108 this is referred to in the conventional ECAE process as one “pass.” As described in further detail below in conjunction with FIGS. 2A through 2E, multiple passes may be performed utilizing ECAE process 100. The microstructure of billet 102 may be controlled via many process parameters, such as extrusion temperature (discussed further below), extrusion speed, ECAE die angle 110, and other suitable parameters. In one embodiment, an extrusion speed within a range of approximately 0.01 to 1.0 inches per minute is utilized.

FIGS. 2A through 2E illustrate an orientation for billet 102 at the start of the first pass and subsequent second pass for multiple pass ECAE processing. FIG. 2A illustrates billet 102 in its starting orientation about its long axis 204 prior to being extruded through ECAE die 104 (FIG. 1) and FIG. 2B illustrates billet 102 after being extruded through ECAE die 104, thereby completing its first pass. As illustrated in FIG. 2A, a shaded area 200 represents the top of billet 102 during the first pass. Shaded area 200 moves from the top of billet 102 to a side 202 of billet 102, as illustrated in FIG. 2B, at the completion of the first pass. Also shown in FIG. 2B is a cross-hatched area 205. Behind cross-hatched area 205 is fully strained ECAE processed material. Note the triangular unprocessed volumetric regions 206 and 207 at each end of billet 102. For subsequent passes, conventional ECAE processing recognizes four separate “Routes,” three of which are illustrated in FIGS. 2C through 2E.

FIG. 2C illustrates “Route A” processing. In Route A processing, billet 102 is inserted into inlet channel 106 with the same orientation that was used during the initial pass. Hence, with reference to FIG. 2A, side 202 of billet 102 faces the same zero degree orientation as was used during the first pass. In other words, for Route A processing, billet 102 is not rotated about long axis 204 for subsequent passes.

FIG. 2D illustrates “Route B” processing. In Route B processing, billet 102 is rotated either plus 90° or minus 90° about long axis 204 from its starting position before being inserted into inlet channel 106 for a second extrusion. In the illustrated embodiment, billet 102 has been rotated plus 90°. For a third pass for Route B, billet 102 is rotated minus 90° about long axis 204 before extrusion. The texture obtained for the material for billet 102 in Route B processing is similar to a texture obtained from a conventional drawing process.

FIG. 2E illustrates “Route C” processing. In Route C processing, billet 102 is rotated 180° from its starting position before being inserted into inlet channel 106 for a second extrusion. For Route C processing, the texture obtained is minimized as compared to the texture obtained as a result of either Route A, Route B, or a combination of these two routes.

Another Route that is conventional to ECAE processing is “Route D.” Although not illustrated, Route D (also referred to as Route C′) involves rotating billet 102 either plus 90° for four consecutive passes or minus 90° for four consecutive passes. Additional Routes E and F are further described in U.S. Pat. No. 6,063,743.

As demonstrated in the examples below, it has been determined that CAE not only reduces grain size of solid metal materials, it also results in a significant reduction in the size and/or frequency of voids or pores (collectively referred to as voids) contained in such solid metal materials. Void reduction is important for electrodes, and particularly brass electrodes, that are used in laser systems including excimer laser systems used in photolithography applications. Reduced void size and/or void count may result in improved electrode performance and may extend the life of the electrode. CAE may be particularly suitable for the manufacture of brass anodes.

In one embodiment, the maximum void size of the solid metal material after CAE may be reduced to less than 20 microns, more particularly, less than 10 microns, even more particularly, less than 5 microns, even more particularly less than 2 microns, and even more particularly less than 1 micron. Average void count (of voids greater than 1 micron in size) may be less than 30/mm², more particularly, less than 20/mm², even more particularly, less than 10/mm². Average grain size may be less than 10 microns, more particularly, less than 5 microns, even more particularly, less than 1 micron.

The void and grain measurements disclosed herein are measured by analyzing a cross-section of material using optical and/or laser microscopy. The resulting optical image is then analyzed visually to identify void frequency, void size and/or grain size. Depending on the level of magnification used, individual voids and/or grains become indistinguishable at a certain minimum size. For example, using optical microscopy at 1000× magnification, the minimum void and/or grain size that can be accurately measured is about 1 micron. Under such conditions, a material for which voids and/or grains cannot be identified is assumed to have a maximum void size and/or an average grain size of less than 1 micron.

Depending on the composition of the solid metal material to be extruded and the process by which the solid metal material is formed, CAE may be carried out under elevated temperature conditions to reduce the formation of cracks during extrusion, to reduce material waste and to further reduce the frequency and size of voids. For example, the solid metal material may be heated prior to ECAE at a temperature of at least about 250° C., more particularly, from about 325° C. to about 400° C. Additionally or alternatively, the CAE die can be heated at temperatures of at least about 150° C., more particularly, from about 250° C. to 350° C. Although heating the solid metal material tends to reduce cracking and material waste during and after extrusion, it may also result in an increased grain size as demonstrated in the examples. Accordingly, in one embodiment, heating temperatures and/or times are used that produce an electrode having an average grain size of less than 2 microns, more particularly, less than 1 micron.

In one embodiment, the solid metal material is passed multiple times through an ECAE die using one of the Routes disclosed with reference to FIGS. 1-2. In such embodiments, the solid metal material may be rotated, for example, 90° or 180° prior to each additional pass so that additional passes occur at different angles relative to the preceding pass. In a further embodiment, the solid metal material is heated in between passes at the same or different temperatures as used prior to ECAE. In a particular embodiment, Route D is used resulting in four passes and a 90° turn in between each pass.

Optionally, hot isostatic pressure (HIP) may be employed prior to or after CAE. When HIP processes are utilized prior to CAE, the number of passes and/or the extrusion temperature (material and die) may be reduced because the HIP process may reduce the frequency and size of the voids to a sufficient extent that fewer CAE passes are required.

### Forming Electrodes (Block 330)

After the CAE process is completed, one or more electrodes are formed from the extruded solid metal material. The manner in which the electrodes are formed is dictated by the shape of the extruded material and the desired electrode shape. If the metal is in the shape of a block, the material may be first rolled into a flat sheet or blank. Rolling can be accomplished with warm or cold rolling techniques. In one embodiment, the solid metal material is heated prior to and/or during rolling to avoid material cracking. After the flat sheet is formed, it can be cut/machined into multiple electrodes. In one embodiment, the electrodes are formed as elongate bars of metal by cutting the sheet in a lengthwise direction. After cutting, the electrodes may be machined to further refine the electrode dimensions.

If the extruded material is in the shape of an elongate cylinder, the cylinder can be subjected to a similar treatment as a block, or alternatively, the cylinder may first be cut into segments corresponding to length of the desired electrode and then rolled into a flattened shape.

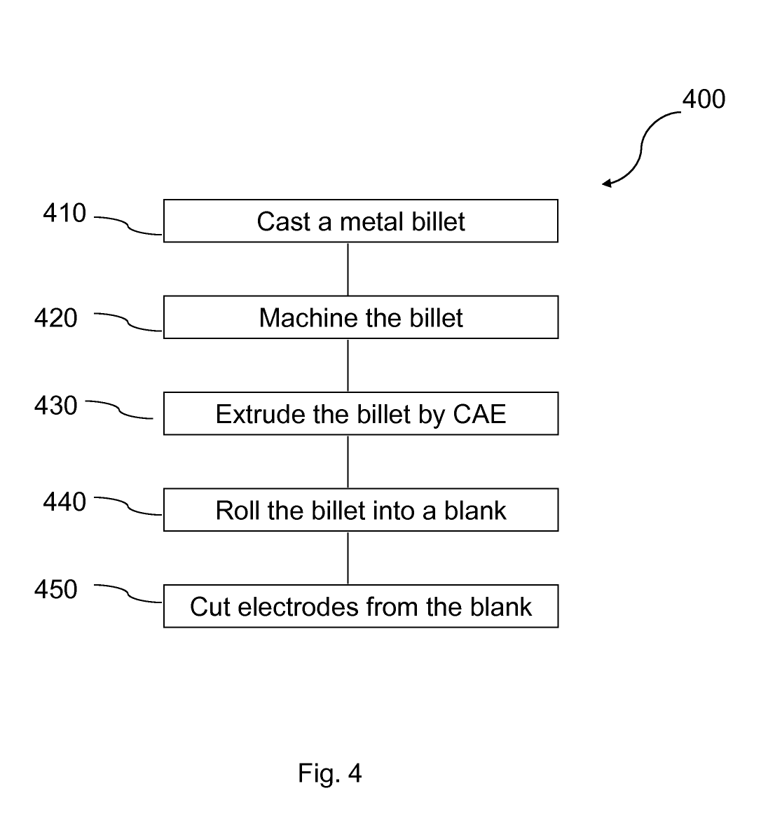

FIG. 4 illustrates another method 400 of forming an electrode. The method 400 includes the steps of casting a metal billet (block 410), machining the billet (block 420), extruding the billet through multiple passes of CAE (block 430), rolling the billet into a blank (block 440), and cutting at least one electrode from the blank (block 450). This method 50 may also incorporate some or all of the heating steps referenced with respect to the method 10, including pre-heating the billet prior to and during CAE, as well as heat treatments steps after CAE.

As further indicated by the examples below, the electrodes formed by the process disclosed herein have reduced void size, void count and/or grain size compared to electrodes that are formed from more conventional casting, forging, rolling and machining techniques. In particular, such electrodes may have a void size of less than 20 microns, more particularly, less than 10 microns, even more particularly less than 5 microns, even more particularly, less than 2 microns, and specifically, less than 1 micron when measured using optical and/or laser microscopy. Void count (of voids greater than 1 micron) may be less than 30/mm², more particularly, less than 20/mm², even more particularly, less than 10/mm² when measured visually by optical or laser microscopy. Grain size may be less than 10 microns, more particularly, less than 5 microns, even more particularly, less than 1 micron when measured visually by optical or laser microscopy.

### Example 1

Two brass billets (Billet A and Billet B) composed of 30 wt % zinc were cast according to conventional permanent mold cast procedures. A raw metal material containing requisite amounts of copper and zinc was contained in a graphite crucible and heated in an induction furnace to a casting temperature of 1950° C. The material was then poured into a book mold to produce a blank having dimensions of 10 in by 6 in by 2.5 in. The blank was analyzed using a standard optical microscope (1000× magnification) to determine void size and void count. The blank had a maximum void size of approximately 200 microns and an average void count of approximately 200/mm² after casting.

The blank was then subjected to a hot forge process at 990° F. until a 50% reduction in billet thickness was achieved. Voids in the blank were again measured and had a maximum void size of approximately 15 microns and an average void count of approximately 150 voids/mm². The blank was then cut and machined to produce Billets A and B having dimensions corresponding to the 3 in by 3 in by 0.6 in cross-section dimensions of an ECAE die inlet channel that intersects with the outlet channel at a 90° angle.

Billet A was then heated at 375° C. for one hour and extruded one time at a maximum load of 71 metric tons through the ECAE die having a die temperature of 300° C. Billet B was extruded through the same ECAE die except that Billet B was subjected to four passes through the ECAE die at max loads of 71 metric tons, 65 metric tons, 69 metric tons and 71 metric tons, respectively. Prior to and in between each pass, Billet B was heated at 375° C. for 1 hour. Billet B was also rotated 90° in between each pass.

Cross-sections of Billets A and B were then analyzed using optical microscopy (×1000) and laser microscopy to determine void size. Billet A had a maximum void size of 4 microns and an average void count of 20 microns. Voids in Billet B were not detectable. Based on the microscopic analysis techniques that were performed it can be inferred that maximum void size for Billet B was less than 1 micron. These results indicate that ECAE reduced the void size of brass billets. The results further indicate that multiple ECAE passes reduced void size more than a single ECAE pass.

### Example 2

Samples from Billet A (1 pass) and Billet B (4 passes) were subjected to different heating temperatures after ECAE to determine the effect of heating temperature on grain size. Table 1 shows the results of these tests:

TABLE 1

| | Billet A Grain Size | Billet B Grain Size |
|---|---|---|
| Temp. (1 hr) | (microns) | (Microns) |
| 350° C. | 11.7 | 2.0 |
| 400° C. | 14 | 5.0 |
| 450° C. | 18.8 | 11.5 |
| 500° C. | 32.5 | 25 |
| 550° C. | 67.5 | 55 |
| 600° C. | 135 | 94 |
| 650° C. | 162 | 144 |

The results set forth in Table 1 indicate that increased heating temperature resulted in increased average grain size.

### Example 3

Billets C and D were formed similarly to Billets A and B except that the hot forge process was eliminated. Specifically, Billets C and D were cast in a mold having dimensions of 12 in by 6.5 in by 2.5 in. The cast billets were then cut/machined and cold rolled to provide dimensions corresponding to the 9 in by 7.8 in by 1.9 in dimensions of an ECAE die.

Billets C and D were then each subjected to four passes through the ECAE die. Billet C was extruded at maximum loads of 570 metric tons, 639 metric tons, 634 metric tons and 619 metric tons. Billet D was extruded at 548 metric tons, 621, metric tons, 580 metric tons and 591 metric tons. Prior to and in between passes, each billet was heating at 400° C. for 1 to 1.5 hours. The die was heated to 300° C. for each pass. After ECAE was completed, both billets were cut/machined to dimensions of 9 in by 4.5 in by 1.7 in.

After machining, Billets C and D were then heated at between 250° C. and 275° C. for 1.5 hours and quenched in water. Billets C and D were then rolled, heated at 250° C. for 1.5 hours, quenched in water, rolled a second time and then heated a final time at 232° C. for 1 hour. Billet C had dimensions of 28.5 in by 4.3 in by 0.47 in. Billet D had dimensions of 27.5 in by 4.1 in by 0.435 in.

Cross-sections of Billets C and D were then analyzed by optical microscopy (×1000) and laser microscopy to determine void count. No voids were detected in either billet. Based on the microscopic analysis techniques that were performed it can be inferred that maximum void size for Billets C and D was less than 1 micron.

### Example 4

Billet C was cut via water jet into 7 bars and Billet D was cut in the same manner into 6 bars. Samples taken from several bars cut from Billet D were then analyzed with an optical microscope to measure grain size at varying heating temperatures. The results are set forth in Table 2. The control sample was tested without additional post-cut heating.

TABLE 2

| Temp. (1 hour) | Grain Size | Brinell Hardness |
|---|---|---|
| Control | Less than 1 micron | Greater than 180 |
| 250° C. | Less than 1 micron | Greater than 180 |
| 300° C. | 1-2 microns | Approximately 120 |
| 350° C. | 2-3 microns | Less than 120 |
| 400° C. | 6-7 microns | Less than 100 |

The results indicate that increased heating temperature, particularly at or above 350° C., increases grain size and reduces material hardness.

The invention has been described with reference to various specific and preferred embodiments and techniques. However, it should be understood that many variations and modifications may be made while remaining within the spirit and scope of the invention.

1. A method of manufacturing an electrode comprising the steps of:
extruding a solid metal material through a channel angular extrusion die having an inlet channel and an outlet channel, wherein the solid metal material comprises copper and at least about 10 wt % zinc; and
forming at least one electrode from the extruded solid metal material.

2. The method of claim 1 wherein prior to extruding the solid metal material is formed to have a length, width, thickness, cross-section, radial or other dimension corresponding to the dimensions of the channel angular extrusion die.

3. The method of claim 2 wherein prior to extruding the solid metal material is formed by casting, machining, hot isostatic pressure or a combination thereof.

4. The method of claim 2 wherein the solid metal material is not formed by hot forging.

5. The method of claim 1 wherein the channel angular extrusion die is an equal channel angular extrusion die with the inlet channel and outlet channel having the same cross-sectional dimensions.

6. The method of claim 1 wherein the solid metal material comprises between about 10 wt % zinc and about 40 wt % zinc.

7. The method of claim 1 wherein the solid metal material comprises between about 20 wt % zinc and about 38 wt % zinc.

8. The method of claim 1 wherein the solid metal material comprises between about 29 wt % zinc and about 32 wt % zinc.

9. The method of claim 1 wherein the equal channel angular extrusion die has a temperature of between about 250° C. and about 350° C. during extrusion.

10. The method of claim 1, wherein prior to extruding, the solid metal material is heated at a temperature of from about 250° C. to about 350° C.

11. The method of claim 1 wherein the solid metal material is extruded through the equal channel angular extrusion die a plurality of times.

12. The method of claim 11 wherein the solid metal material is heated between extrusions, rotated between extrusions or both.

13. The method of claim 1 wherein the forming step comprises, cutting the solid metal material into a plurality of elongate bars.

14. The method of claim 1 wherein the electrode has a maximum void size of less than two microns.

15. The method of claim 1 wherein the electrode has a maximum void size of less than one micron.

16. An electrode comprising copper and between about 20 wt % and about 40 wt % zinc, wherein the electrode has an average grain size of less than 2 microns and a maximum void size of less than 5 microns.

17. The electrode of claim 16 comprising an average void count of less than 30 voids/mm² for voids of greater than 1 micron.

18. The electrode of claim 16 comprising an average grain size of less than 1 micron.

19. The electrode of claim 16 wherein the electrode comprises between about 29 wt % and 32 wt % zinc.

20. A laser comprising at least one electrode comprising copper and between about 20 wt % and about 40 wt % zinc, wherein the electrode has an average grain size of less than 2 microns and a maximum void size of less than 5 microns.
